(19) United States
(12) Patent Application Publication
(10) Pub. No.: US 2003/0014442 A1
(43) Pub. Date: Jan. 16, 2003

(54) Web site application development method using object model for managing web-based content

(76) Inventors: Clyde K. Shiigi, Aiea, HI (US); Jeffrey S. Malins, Pearl City, HI (US); Keith D. Hamasaki, Honolulu, HI (US)

Correspondence Address: LEIGHTON K. CHONG, OSTRAGER CHONG & FLAHERTY (HAWAII), 841 BISHOP STREET, SUITE 1200, HONOLULU, HI, 96813, US

(21) Appl. No.: 10/190,369

(22) Filed: Jul. 5, 2002

Related U.S. Application Data
(60) Provisional application No. 60/305,555, filed on Jul. 16, 2001.

(51) Int. Cl. G06F 15/00

(52) U.S. Cl. 707/513

(57) ABSTRACT

A system and method for developing an application for serving a document to a client in a client/server network employs an Object Model which defines templates, extensions, documents, and content objects in a template inheritance model. The Object Model serves a document, such as a webpage of a Web site application, by combining the structure and content inherited from a template and extensions in the template hierarchy. The templates specify the structure of the document and include tags as placeholders for content objects to be incorporated in the document. Extensions descend from either a template or another extension, and can expand upon the number of tags specified in a parent, add additional formatting to the layout, and/or refine the definition of tags that already exist in the inheritance hierarchy. When a document is to be viewed or served, a page server retrieves the template hierarchy and incorporates all tagged content in the structure inherited from the template and its extensions. The Object Model provides a framework for developing Web sites and other applications that is more robust and simpler to manage than the traditional file directory model of conventional Web applications. This framework makes it possible to create complex and highly structured Web applications that are efficient to develop and easier to maintain, and without ever having to write source code.

This U.S. patent application claims the benefit of the priority date of U.S. Provisional Application No. 60/305,555, filed on Jul. 16, 2001, entitled “Programming Method for Web-Based Content Management”.

### TECHNICAL FIELD

This invention generally relates to a Web site application development method, and more particularly, to one in which web-based content to be used in the Web site application is managed using an object model.

### BACKGROUND OF INVENTION

Object-oriented programming (OOP) has been developed over the last twenty years to deal with the increasing complexity of software development. It is based on the idea of compartmentalizing of both data and functions that are logically related, in the goal of allowing for maximum re-use as well as centralization of information. OOP methods are characterized by defining data and function program components as objects in terms of types, classes, and hierarchies, with the ability of objects in a class to inherit or carryover characteristics from a higher class to which it is subordinate in a defined hierarchy. The use of inheritance in a hierarchy of objects allows new classes of objects or extensions of a given class of objects to be readily expanded and elaborated upon, such that complexity in a large software development can be more easily managed.

However, OOP methods have been used solely for managing the complexity of software programming code, i.e., the compiling or interpreting of program code to produce binary applications. In recent years, high-level applications development systems, such as the JAVA development environment from Sun Microsystems, Mountain View, Calif., NET development environment from Microsoft Corp., Redmond, Wash., and others, offer robust collections of tools, libraries, and pre-programmed functions that allow applications to be quickly developed by programmers using high-level programming components without having to program at the code level. Such applications can be widely deployed and readily interfaced with other applications developed with the same or a compatible development environment. The use of OOP programming methods to develop native software code is thus becoming superseded by the growing use of high-level development environments for more intuitive programming of customer applications.

Even within high-level applications development environments, the management of large volumes of distributed data and content presents a serious challenge. Web site applications are typically characterized by a multitude of pages, subpages, and related or linked Web sites which can share content or generate content to be shared, or the format of the site or its pages or the content used thereon may be updated and changed frequently. The sharing or updating of content or the making of changes to the format of webpages on a site typically requires that each page or content element be modified by the webmaster or Web site developer as an individual customization, thereby making it a very labor intensive and slow process.

### SUMMARY OF INVENTION

The present invention seeks to provide a powerful new method of applications development, and particularly, Web site applications development, by introducing an “object model” and related object-oriented methods for use in managing content in an applications development environment.

In accordance with the present invention, a system and method for developing an application for serving a document to a client in a client/server network comprises the following basic steps:

(a) defining a template for an intended document which specifies aspects of structure and content that the intended document is to have;

(b) defining at least one template extension for the intended document in a hierarchy with the template which specifies other aspects of structure and other content that the intended document is to have, wherein the template extension inherits the structure and content specified in the template;

(c) defining a document which refers to the template hierarchy of said template and said at least one extension;

(d) defining a plurality of content objects to be incorporated in the intended document and referencing the content objects in the template, template extension, and/or document in order to cause the content objects to be incorporated in any resulting document;

(e) storing the template hierarchy of said template, at least one template extension, document, and content objects in a storage repository; and

(f) generating a resulting document in response to a client request by retrieving the template hierarchy and combining the structure and content inherited from said template and the at least one template extension with the document and the content objects referenced therein.

In a preferred embodiment of the system and method of the present invention, an Object Model manages the creation, storage and retrieval, and management of structural elements and content elements for creating webpages for a Web site application. The Object Model employs an editor component having a visual interface for a user to create and edit templates, extensions, documents, and content objects of template hierarchies for documents to be sent in response to client requests. The Object Model manages the structural elements and content elements as template hierarchy data stores them in associated repositories. In response to a client request for a webpage, a page server retrieves the template hierarchy data for the webpage and assembles all content objects referenced therein. An extension manager is used to manage interconnection of the Object Model to outside or extended resources, and an integration interface is used to manage the interfacing of data imported from or exported to any external systems.

The Object Model of the present invention uses a template inheritance model for defining objects in hierarchies for the generation of webpages of a Web site. A basic template hierarchy includes a master template, at least one template extension, and a document, all of which can reference content objects through tagging. The document is the topmost layer to the master template and template extension(s) and all content objects incorporated therein.

Templates are the root of the Object Model hierarchy. Templates specify the formatting of the document and include tags as placeholders for content objects to be incorporated in the document. Extensions descend from either a template or another extension, and can expand upon the number of tags specified in a parent, add additional formatting to the layout, and/or refine the definition of tags that already exist in the inheritance hierarchy. Documents can descend from either templates or extensions. When a document is viewed or served using the page server, all tags are combined from it and its templates and extensions.

When a user uses the editor to create or edit a template, they are presented with a text area to enter HTML text, inline scripting code and/or object tags. HTML markup code can be inserted around the object tags to give layout instructions for the content that the objects incorporate. Inline scripting code can be interspersed with the tags and HTML to allow the layout of the template to be modified on the fly when the page is displayed. The object tags are replaced by content objects when the template is rendered into a web page.

When the user creates or edits an extension, they are presented with a list of existing (inherited) tags. A set of routines starts at the base template of the inheritance hierarchy and loads its tag list, then steps up through any extensions up to the extension being edited and merges in all changes to a master tag list. The master tag list is then displayed, and the user can make any desired changes, additions, or refinements to these definitions at this extension level that will override definitions or changes made further down in the hierarchy.

When the user creates or edits a document, they are presented only with the tags that have been left undefined in the parent templates and extensions since these are the only tags which need to be filled by the document at the topmost level of the hierarchy. This tag list is retrieved using the same method used for extensions; however, previously defined tags are trimmed from the list before it is displayed. When the document is saved, the consistency of its tags is checked, and a reference to the unique ID of its immediate parent (either an extension or a template) is stored for later use by the page server in retrieving the associated template hierarchy.

The page serving process starts when a request for a document comes from a client (web browser). The request is forwarded to the page server which determines which document (webpage) has been requested, and it retrieves the document either from the cache or from the system database. The serving process begins by retrieving the template hierarchy data and using the data to construct a table object which represents the combined HTML, runtime script, and object tags for the associated template hierarchy. The table object incorporates all tagged content and objects that are inherited from the parent templates and extensions, as well as those tags which have not been defined in the template hierarchy (those defined in the document). When the document is served, the contents referenced by the tags are retrieved from the system database and filled in the structure of the document specified by the template hierarchy in order to complete the document to be sent back to the client.

The Object Model of the present invention provides a framework for developing Web sites and other applications via the template inheritance model that is more robust and simpler to manage than the traditional file directory model of conventional Web applications. Developers can easily customize the look and feel of a Web site application at a high level by defining a template hierarchy and allowing it to cascade throughout the application. The Object Model enables an unlimited span of webpage content to be implemented and managed simply by creating, changing or adding templates, extensions, documents, content objects, and resources, instead of the conventional practice of changing webpages with manual code or building new ones from scratch. This framework makes it possible to create complex and highly structured Web applications that are efficient to develop and easier to maintain, and without ever having to write source code. The principles of the invention disclosed herein may be applied similarly to other development environments for applications operable in client/server networks.

Other objects, features, and advantages of the present invention will be explained in the following detailed description of the invention having reference to the appended drawings.

### BRIEF DESCRIPTION OF DRAWINGS

FIG. 1 is a schematic diagram providing an overview of a preferred embodiment of the system in accordance with the present invention showing the use of an Object Model at its core.

FIG. 2 is a schematic diagram illustrating the template inheritance model used in the Object Model of the present invention.

FIG. 3 illustrates an example of template definition in the template inheritance model.

FIG. 4 illustrates assigning objects to templates and extensions using tags.

FIG. 5 illustrates an example of multiple inheritances using a remote expander.

FIG. 6 illustrates a document generated by multiple inheritances using a remote expander.

FIG. 7 illustrates an example of dynamic template swapping to generate different documents.

FIG. 8 is a schematic diagram illustrating the process for document (page) generation used in the Object Model.

FIG. 9 is a diagram of the logic used by the Object Model to generate a master tag list for elements referenced in a template hierarchy.

FIG. 10 is a schematic diagram illustrating use of the master tag list for storage of elements referenced in a template hierarchy.

FIG. 11 is a schematic diagram illustrating the use of an extension to the Object Model's core system to create an extended system.

FIGS. 12A and 12B illustrate system platform embodiments employing a single server, and an application server combined with a database server, respectively.

FIG. 13 is a screen shot of a dialog box of the editor interface for setting up tag definitions.

FIG. 14 illustrates the generation of a table for all elements referenced in a template hierarchy for use in document (page) generation.

### DETAILED DESCRIPTION OF INVENTION

The following describes a preferred embodiment of the invention method and system for creating Web applications. The preferred system is developed in the JAVA programming environment. The Web application is designed to serve up webpages with diverse content in response to requests from clients in a client/server network such as the Internet. However, it is to be understood that the principles of the invention disclosed herein may be applied similarly to other applications development environments that are used to develop applications that require complex content management to generate documents that are served to clients in any client/server network. For example, the invention may be similarly used for Web applications developed in the .NET development environment offered by Microsoft Corp., Redmond, Wash., for e-commerce enterprise applications developed in the WEBSPHERE development environment offered by IBM Corp., Armonk, N.Y., for mobile data applications developed in the BREW development environment offered by Qualcomm Inc., San Diego, Calif., and many others.

System Overview

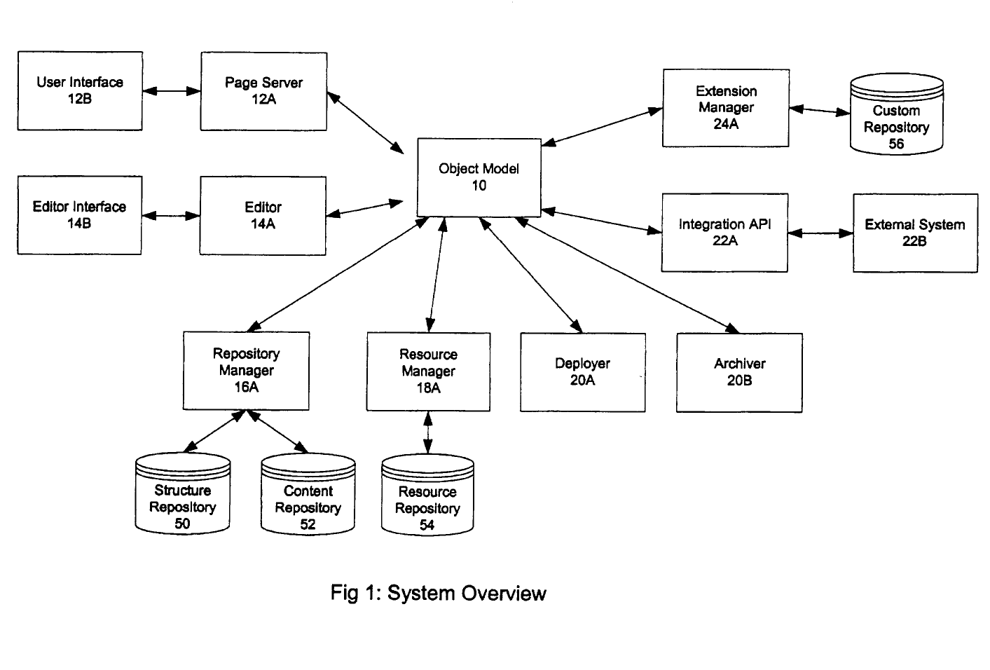

Referring to FIG. 1, a preferred embodiment of the present invention has as its core system an Object Model 10 which generates documents (webpages) in response to client requests in a client/server network. The overall framework of the system is an object-oriented environment consisting of templates, objects, documents, and resources which are used by the Object Model to generate webpages. Templates (including a master template and extensions) are structural elements that define the visual and programmatic structure of a webpage or set of webpages for a particular Web site application, by specifying the formatting of the webpages and the content objects that will appear or be used on the webpages. Objects represent different types of content elements that are to appear on the webpages. Instances of content objects are created in the Object Model and are referenced by tags inserted in the templates as placeholders for the actual content elements that are incorporated in the resulting document. Whereas an object represents a type of element on a webpage and serves as a placeholder, a resource is the actual content element referenced by the placeholder, such as text, graphics, video or animation files.

The Core System also includes a Repository Manager 16A which provides an interface for the Object Model 10 to a Structure Repository 50 for storing structural elements (templates) and to a Content Repository 52 for storing content elements. A Repository Manager 16A translates the logical design used in the system into the structure and format of the repository. A Resource Manager 18A stores and manages resources in a Resource Repository 54. A repository is typically, but does not have to be, a relational database.

A Page Server 12A provides a User Interface 12B of the Object Model 10 to end users accessing the Web site application. The Page Server 12A processes incoming requests to the system from users, and the Object Model 10 analyzes the internal (object) representation of the system, builds the structure of the response based on the internal (object) model, and delivers the content via a page (or document) to be visually displayed via the user's browser in response to the user's request.

An Editor 14A provides an Editor Interface 14B of the Object Model 10 to webpage content authors, managers and site administrators. The Editor is used to design, build and maintain the Web site and its webpages.

A Deployer 20A is used to deploy content for previewing edits and to deploy content between staging servers. In general, it manages the deployment of content between different database and different hosts. It is used to allow data to be moved between server environments from within the content Editor Interface. The Archiver 20B is used to archive data generated by the Object Model and to import data to or export data from the repositories.

An Integration API 22A is used to manage the interfacing of the Web site application with external systems. The Integration API 22A allows for connection of the Object Model to any other system by conversion of functions and data coded in external programming languages (databases, directories, peripherals). Through the Integration API, the External System 22B can “request” data from or be “queried” for data by the Object Model.

An “extension” is any collection of functionality that can be added modularly to the Core System, for example, new content elements, which may be static, dynamic, etc., new user interface (GUI) elements for the Editor for creating and modifying new content elements, and editing of data from external sources within the Object Model. The Extension Manager 24A manages the interfacing with extensions to allow the depth and breadth of the Object Model to be expanded (without having to perform major code changes). For example, a template in the Core System can seamlessly use an external content object that is added by an extension, such as allowing the viewing and editing of data in an external database. The Extension Manager 24A provides specifications for and manages the processes for interconnection of the Core System to external sources, and its data are stored in the Custom Repository 56.

Template Inheritance Model:

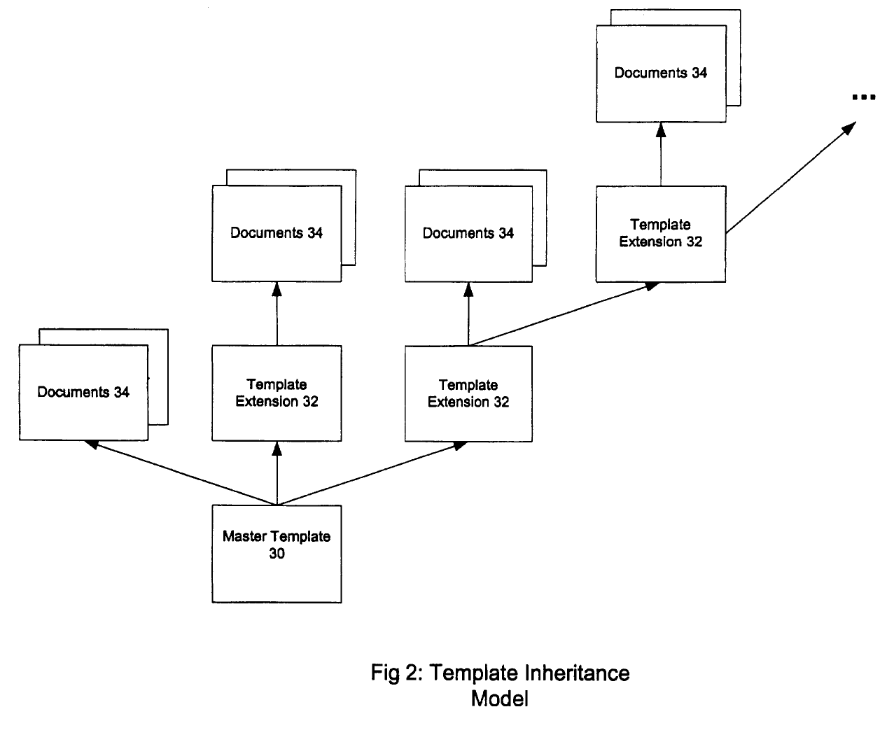

At the heart of the Object Model 10 in the present invention is the use of a template inheritance model for defining objects in hierarchies for the generation of webpages of a Web site. Referring to FIG. 2, a basic hierarchy includes a Master Template 30, at least one Template Extension 32, and Documents 34. The Master Template 30 is a file-system element that defines a basic or common structure or formatting of a webpage (or any other type of document in general). It is not the webpage itself but rather specifies the format and content for a webpage; in the form of HTML data and objects to be included. The Template Extension 32 is any further template that inherits the basic structure and content of the Master Template 30 and specifies other additions or refinements to its structure and content. Each Document 34 is the result of the fusion of the Master Template and any Template Extensions in the associated template hierarchy and all the content elements incorporated therein to create a webpage.

In addition to inheritance behaviors, templates can be defined as abstract or final. Abstract Templates are templates that require further definition before they are used to create documents. Abstract Templates are used to communicate to webpage developers that the template is not complete and further refinement is needed before the template can be used. Final Templates are templates which cannot be further extended through inheritance. This is useful for ensuring that changes to a template will not cause unpredicted effects on documents.

Template Definition Example

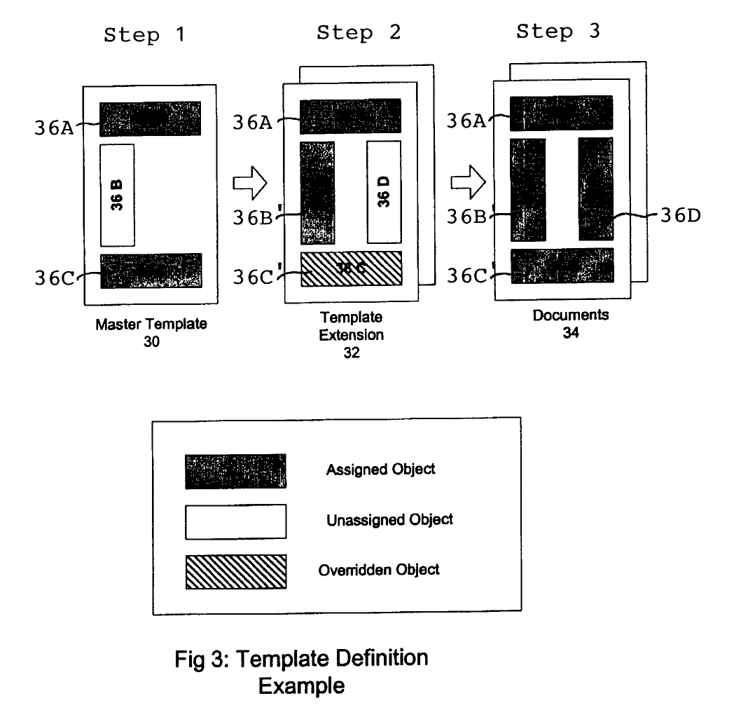

An example of template definition is shown in FIG. 3, illustrating how inheritance, overriding of objects between templates, and customization at extended levels of the template hierarchy can be used to produce diverse webpages. In Step 1, the Master Template 30 is defined as containing the structural formatting for a webpage, and three objects (content placeholders for the actual content): a header 36A, a navigation bar 36B, and a footer 36C. The header 36A is assigned (dark shading), meaning that its attributes are set, for example, it is to have a background image and text content. The navigation bar 36B is unassigned (white box), meaning that its attributes will be assigned in an extension further in the template hierarchy. The footer 36C is also assigned.

In Step 2, the Template Extension 32 inherits the structure of the Master Template 30 but includes three changes. First, the previously unassigned navigation bar 36B is defined, and thus becomes an assigned navigation bar 36B′. The navigation bar was left unassigned at the Master Template level in order to allow flexibility to define different navigation bars through template extensions for different webpages of the Web site. This Template Extension 32 is used to define a particular navigation bar for a particular webpage of the site. Second, the footer 36C inherited from the Master Template is overridden and replaced with another footer object 36C′. The overriding function is provided to give flexibility to make changes to specific template instances. Third, a new content area 36D is added by the Template Extension 32.

In Step 3, a Document 34 is generated as the end result containing the sum total of all the objects that have been defined and/or changed. The header 36A has been inherited from the Master Template 30. The navigation bar 36B′ and the changed footer 36C′ have been inherited from the Template Extension 32, and the content area 36D is defined (assigned by incorporation of the actual content) at the Document level.

Using objects in the template inheritance model accelerates the development of a Web site application by enabling developers to assign objects to a template instead of hand-coding every element on a webpage. If the format or structure of a webpage or the objects contained therein need to be changed, a template can be changed once or overridden in an extension, and the change will be inherited in any subsequent extensions or documents. If an object in a webpage needs to be changed (for example to reflect a change in the HTML standard), the object is changed only once and the change will automatically be reflected (incorporated) everywhere the object is used. Objects can be used both for the presentation of actual content resources as well as for the logic of other functions used with webpages, such as security, application integration and database connectivity functions.

Developers can create and organize frequently-used objects in the Object Model using its object management functions. Objects can be defined and assigned at the template or document level, and can be reused and shared by multiple instances of templates or documents. Objects created for templates or documents can be stored in repositories for other uses if desired by the developer. This object-oriented approach to building Web site applications provides an extremely powerful development environment. The same objects can also be imported from or exported to other systems, for example, they can be utilized in separate Internet, intranet and extranet applications based on the same Object-Model.

The functionality of the system is enhanced by the use of pre-built objects stored in repositories for reuse in development of Web site applications. Some examples of pre-built objects which may be found useful include:

Text—Basic block of Web page text

Image—Any Web-compatible graphic format.

Article—Text with rich text formatting, including tables and images.

Browser Detector—For determining what type of browser a visitor to the site is using

Date/time—Calculates and displays date and time

HTML Box—A box in which any generic object can be created in HTML.

Enhanced HTML box—A complex HTML page that allows the defining of tags that will pull in external data when a page is generated.

Hyperlink—For creating links to external Web sites or to other pages within the same site. Used to insert a hyperlink, with numerous options for formatting the link.

Object List—A list of objects that can be displayed by date, randomly, etc. An object list can display one or more content elements within the same area on a Web page

Randomized graphics—A collection of graphics that are randomly displayed when the page is generated.

Search Input—Creates a search bar so that users can search the site.

Search Output—For creating a searchable Web site. Defines how search results are sorted and displayed.

Conditional Expression—Displays a different object depending on the condition defined in the expressions.

Folder Lists—Lists of articles (randomized headlines for example) that are built on the fly from all articles within a particular folder.

Wireless Content—For presenting content in applications for wireless devices such as mobile phone and PDAs.

Web Poll—For creating a “votelet” that lets site visitors participate in a quick poll on hot issues.

Forms—For presenting and capturing data and storing into a back-end database.

Database Reporting—This object reads data from a custom database and displays it in online report format via the customer's Web site.

Security object These objects provide common security features such as user authentication, user roles, password changes, and password request.

Custom objects can be developed in the development environment's programming language (JAVA in this embodiment) to perform unique functions. Custom objects can be developed externally (using any programming language that can be converted through the Interface APIs) or internally from within the Editor. Examples of custom objects include: zip code saver, automobile configurator, and user authenticator. Once an object has been defined, new objects can be created by extending the object. Extended objects inherit the properties of objects, similar to the template inheritance model. In addition, a group of objects can be collected to form a composite object.

Whereas an object encapsulates the data and/or functionality of an element in a Web application, global resources are the actual elements themselves. Examples include elements formatted as JPEG, GIF, PDF, Flash, video, or MS Office files, as well as functional blocks of HTML or JavaScript code. The system can be configured to support a wide variety of file types. Global resources are available for reuse throughout the Web site. Because global resources are stored in a central repository, changes to a resource can be made in a single location. In addition, performance is improved by the use of a shared global resource that has already been cached by the system. Having resources available globally speeds development because resources are developed and deployed in only one area, greatly reducing maintenance time. Raw files such as GIF, JPEG, PDF, video files, etc., are stored and organized by the Resource Manager. Objects point to the Resource Manager to specify the content resource they need to create an instance of an object. Users can make changes to a resource throughout the system by accessing it once in the repository.

Defining Objects in a Document Through a Template Hierarchy

Templates are the root of the Object Model hierarchy. Templates can specify an initial list of tags to be filled in a document as well as the formatting of the content represented by those tags using HTML markup code. Extensions descend from either a template or another extension. Extensions can expand the number of tags specified in their parent, add additional markup code to the layout, and/or more closely refine the definition of tags that already exist in the inheritance hierarchy. Documents can descend from either templates or extensions. Documents serve as a cap to a hierarchy, i.e., they provide the closure between content objects referenced by the set of tags defined in the parents, as well as define any unassigned tags. Thus, when a document is viewed or served using the Page Server, all tags defined in the template hierarchy are used to incorporate the corresponding content elements in the resulting document.

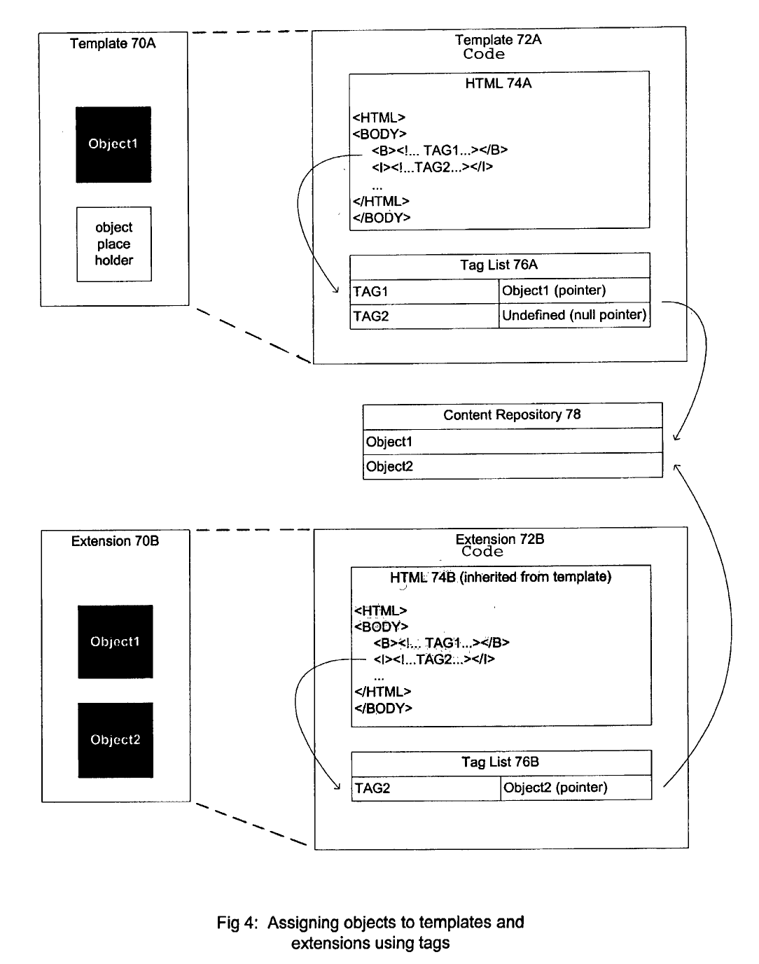

Referring to FIG. 4, the logic sequence for assigning objects to templates and extensions using tags is illustrated. A Template 70A is shown visually on the left hand side created with an Object1 which has assigned content and an Object2 which is a placeholder with content not assigned. The Template Code 72A is shown on the right hand side having HTML code 74A defining the formatting of Object1 and Object2 by referencing assigned tags TAG1 and TAG2, respectively. A Tag List 76A is generated (as described previously) with reference to Template Code 72A showing that TAG1 is assigned a pointer (address) for the actual content element for Object1 which is stored at the corresponding address location in the Content Repository 78, whereas TAG2 is “Undefined”, i.e., assigned a null pointer because the actual content for Object2 has not yet been assigned. The Extension 70B is next in the hierarchy with Template 70A and was created with both Object1 and Object2 assigned to actual content elements. The Extension Code 72B has HTML code 74B which was inherited from Template Code 72A, and its Tag List 76B shows that TAG2 is now assigned a pointer for the actual content element for Object2 stored in the Content Repository 78. The Tag List 76B for Extension 70B would be merged with the Tag List 76A for Template 70A when a Master Tag List is created.

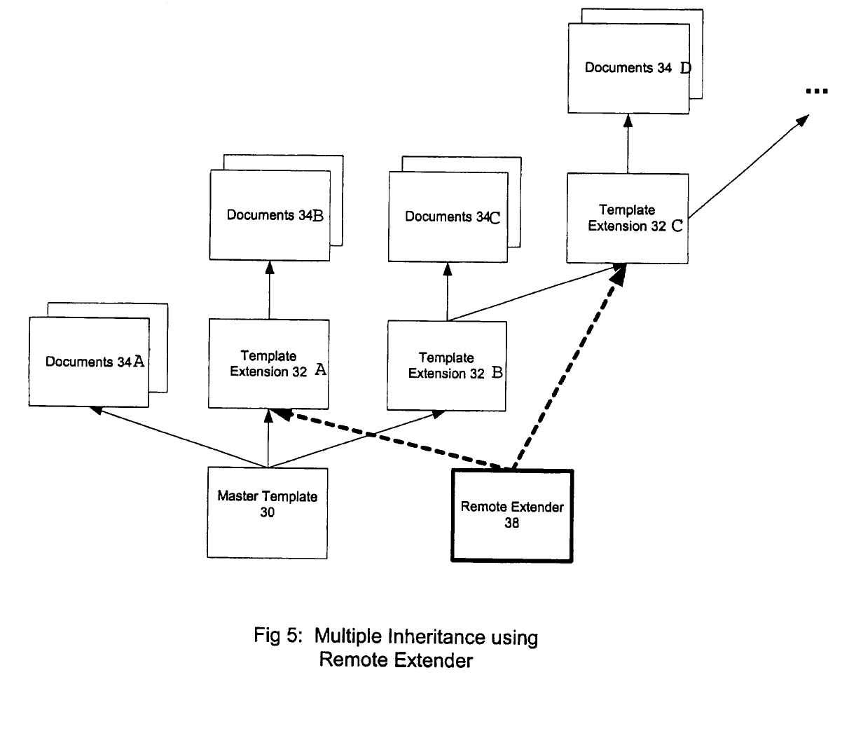

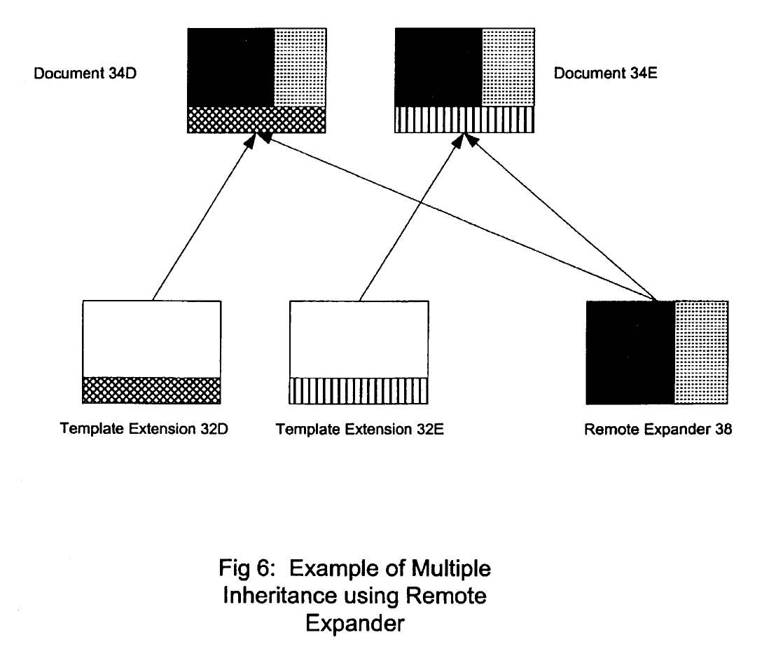

FIG. 5 illustrates an example of multiple inheritances through the use of a remote extender. A Document 34 has structure and content generated from a Template 30 and Template Extension 32, as described previously. A Remote Extender 38 is similar to a template extension in that it can establish the format and content for a set of Documents 34. The Remote Extender 38 works in conjunction with Template Extension 32 to dictate the final format and content of the Documents 34. The Remote Extender differs from the Template Extension in that the latter is part of an inheritance hierarchy, whereas the Remote Extender does not work by inheritance, cannot be extended, and is self contained. Remote extenders can be inserted arbitrarily into an existing hierarchy of templates and extensions. Its usefulness arises from the ability to insert the same extender into multiple template hierarchies. In the example illustrated in FIG. 6, the Document 34B contains elements from Template Extension 32A and Remote Extender 38, whereas Document 34D inherits features from Template Extension 32C and Remote Extender 38.

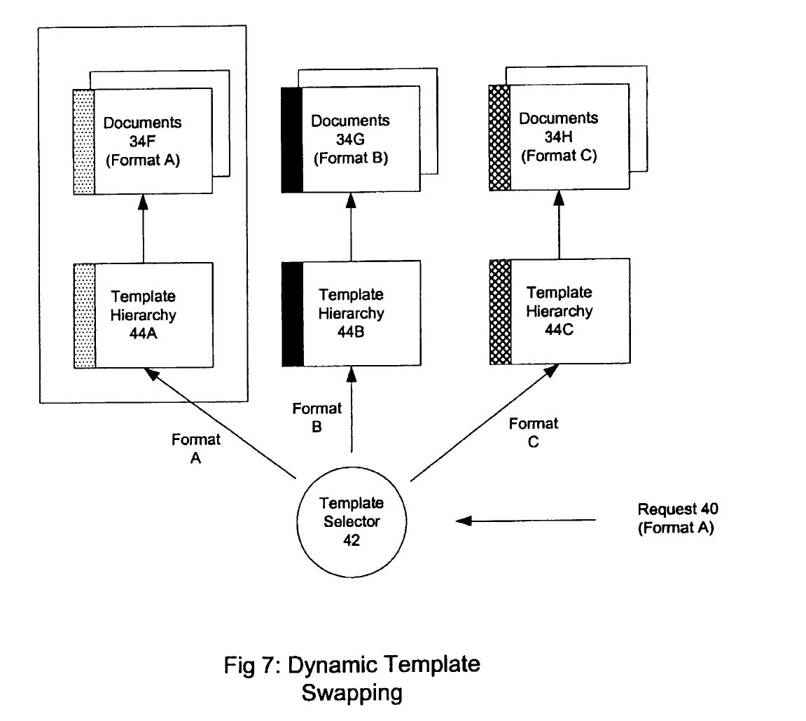

The Object Model determines the template hierarchy to be used to generate a document requested by an end user (client in the client/server network) and switches or swaps template hierarchies depending on the type of document required to respond to the request. This is referred to herein as “dynamic template swapping”. As illustrated in FIG. 7, an incoming request 40 specifies a document which is of the type referred to as Format A, for example, a Web page to be displayed on a PC, a Mac computer, a PDA, or a mobile phone. Based on the request, the Template Selector 42 of the Object Model will select an appropriate Template Hierarchy 44A resulting in Documents 34F which are in Format A. Similarly, Documents 34G required in Format B are generated by selecting Template Hierarchy 44B, and Documents 34H required in Format C are generated by selecting Template Hierarchy 44C.

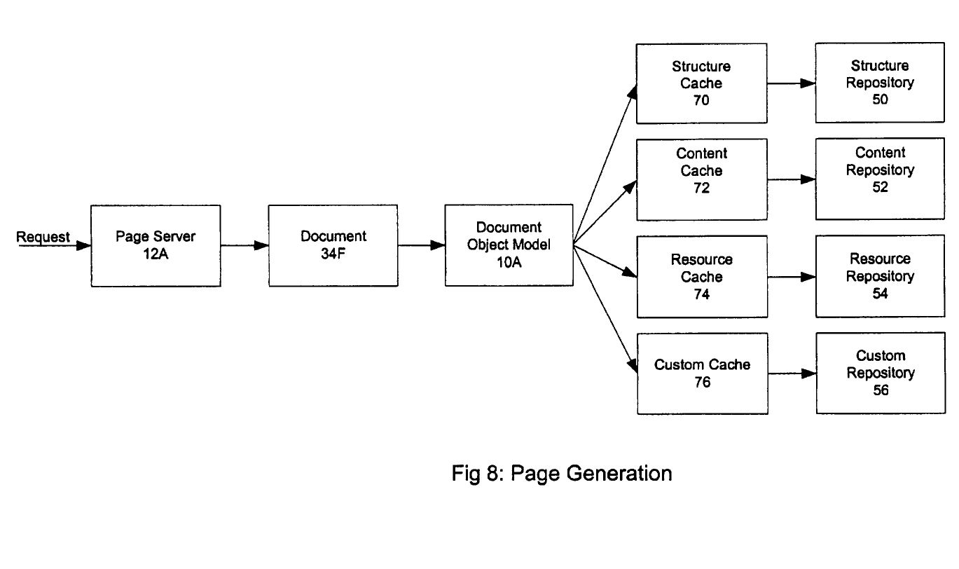

In FIG. 8, the process by which the system processes a request to generate a document (page) is illustrated. The request for a document is forwarded to the Page Server 12A. The Page Server 12A identifies the type (F) of the requested Document 34. The Object Model 10A for the requested Document 34 is invoked. The Object Model 10A defines the template hierarchy that is required to make up the document, and retrieves the templates, extensions, objects, resources and custom elements specified from the Structure Cache 70 first, then the Structure Repository 50 next, and similarly, Content Cache 72 then Content Repository 52, Resource Cache 74 then Resource Repository 54, and Custom Cache 76 then Custom Repository 54, respectively. Pages are computed on the fly from the combination of the Object Model and the repository data. The caches are used to store the data previously retrieved in a page generation so that it can be used for the next page generation requested, unless a change to the page has been made. The exception to this is when ‘active’ objects are used, requiring that certain portions of the page be computed from the Object Model on each request (although other portions are cached).

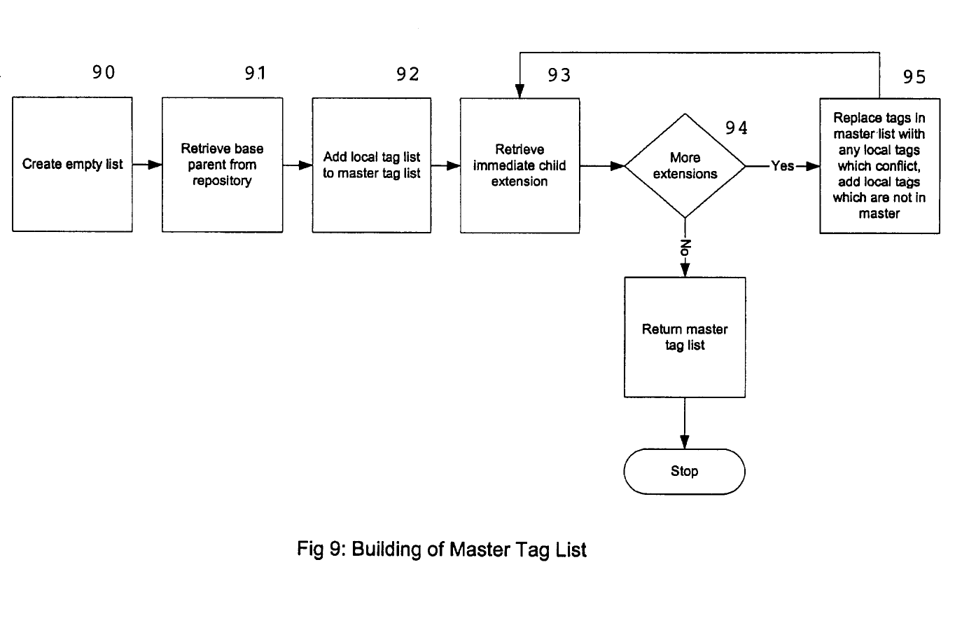

Referring to FIG. 9, the logic used by the Object Model for building a Master Tag List for the elements in a template hierarchy is illustrated. At block 90, an empty list form is initialized, then at block 91 the base parent template is retrieved from storage and at block 92 its tag list is put on the Master Tag List. The process continues at block 93 by retrieving the next immediate child extension, and at block 95 its tag list is merged with the Master Tag List and any conflicting, superceded, or overridden tags are removed. The process continues in a loop until all extensions have been processed, and ends when the test in block 94 returns a result that there are no more extensions.

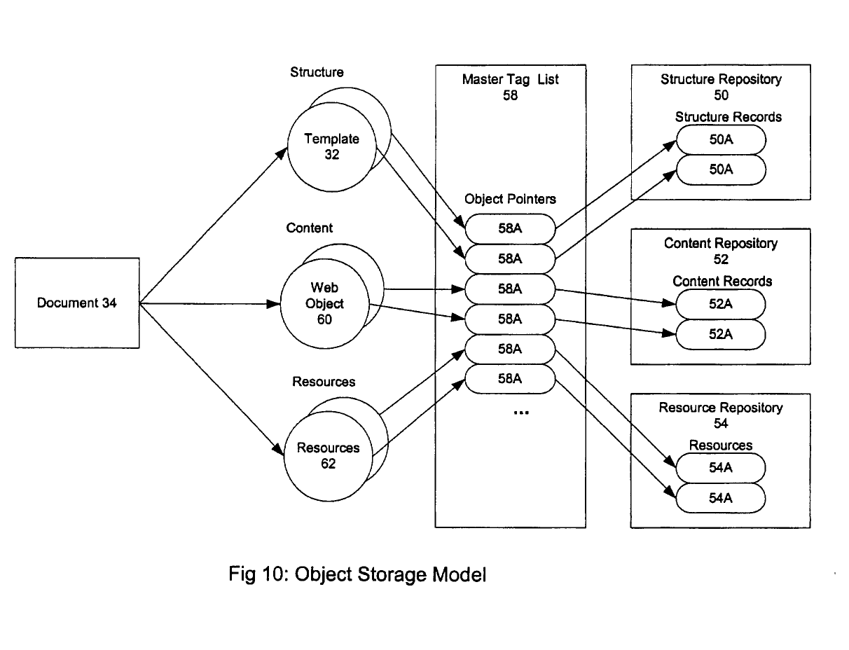

Referring to FIG. 10, the process by which the Object Model stores (and retrieves) elements using the Master Tag List 58 is illustrated. Document 34 is constructed from three types of elements: structural elements (Templates 30/32), content elements (Web Objects 60), and resource elements (Resources 62). The Object Model generates the Master Tag List 58 (as described previously) for the Document 34. The Master Tag List 58 contains a list of Object Pointers 58A which point to the addresses for data records stored in the repositories. It thus identifies where Structure Records 50A are stored in the Structure Repository 50, where Content Records 52A are stored in the Content Repository 52, and where Resources are stored in the Resource Repository 54.

The Object List is also used to manage the transfer of data to generate the document. There are several types of data transfer processes which can be handled by the system. An Import/Export transfer process uses the Object List to catalog the data for parts of or the entire Web site for importing and exporting. This feature can also be used for manual Web site changes. A Same Server Deploy process uses the Object List to transfer data from one process to another on the same server, such as data for page editing to page preview. A Separate Server Deploy process uses the Object List move data between servers, for example to move data for a Web site from a staging environment to a production environment. A Backup process uses the Object List to backup or restore a single deploy event. The benefit of this design is that structure and content elements are manipulated using the same types of functions, which means a consistent GUI can be used and the same code base. An additional benefit is that both structure and content can be stored in the same repository or type of repository.

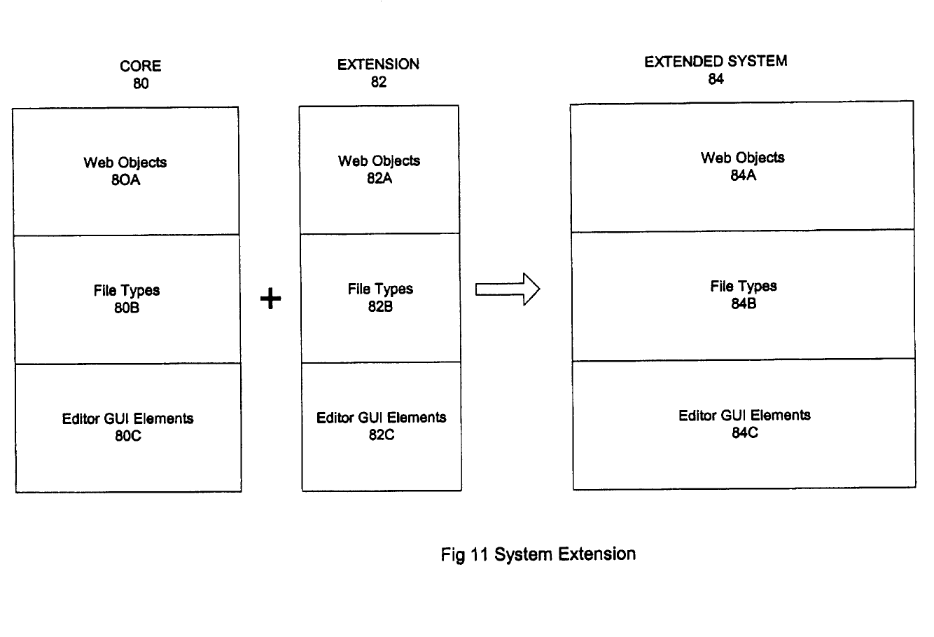

The Object Model employed in the present invention lends itself readily to extensions of the system beyond the server which processes the Web site application. The system can be extended to interface with any external source of objects, resources, and other elements that can be used in the generation of the application's webpages. As illustrated in FIG. 11, the Core 80 of the system can be extended through an application programming interface to add extensions or custom functionality of Extension 82 to create an Extended System 84. The Core elements consist of Web Objects 80A, File Types 80B and Editor GUI Elements 80C. An extension system or database can contain parallel elements of Web objects 82A, File Types 82B and GUI Elements 82C. The result in the Extended System of Web Objects 84A, File Types 84B and GUI Elements 84C that has extended or custom functionality integrated with the Core system. Extension Systems can be pre-built and offered as add-on modules to the Core System, such as extensions for an intranet solution, an e-commerce extension, and internationalization extension to a core Web site application.

System Implementation of Object Model

In this example, the Core System is implemented as a Java application that can run on the following application platforms for the various functions required in the system: Operating System; Java Application Server; Relational Database; and LDAP Directory Server. At the bottommost layer, the Core System runs inside of a readily available operating system, such as Microsoft WINDOWS™ or freely available GNU/Linux on a server computer. The application code is written in the Java programming language and runs as a Web Application inside of a Web Application Server implementing the J2EE and Java Servlet 2.3 standards. Alternatively, a free application server, ‘Tomcat’ is available from the Jakarta project of the Apache Foundation, while commercial application servers are sold by IBM, BEA Systems, and Macromedia Inc. among others. The Web Application Server is run inside of a Java Virtual-Machine (JVM) application that sits on top of the underlying computer operating system. JVM implementations are freely available from Sun Microsystems and IBM.

The source code is compiled with the compiler distributed with the mentioned JVM implementations as well as a compiler called ‘Jikes’ provided separately by IBM. Management of the application build process may be handled through a tool called ‘Ant’ that is freely distributed by the Jakarta project. This application uses the standard Java libraries provided with the JVM. Script interpreter libraries from IBM, Netscape Communications, and others may be used together via a runtime scripting framework, such as BeanShell™, provided by IBM. XML, DOM, Regular Expression, XSL, and Web Service libraries from the Jakarta project may also be used. A single physical repository is used to store both the Web site content and the structure by which this content is organized. Both content (web objects) and structural elements (templates, extensions, documents) are stored as entries inside of a virtual file system. This file system is implemented as a set of index tables inside of a database instance in a relational database manager (DBMS), such as those available from Oracle Systems, IBM, or the freely distributed PostgreSQL.

A single table in the database holds all file records in the repository file system. Data columns in the table fall into two groups: file properties columns and file relationship columns. The property columns are a unique file ID that is generated at the time the file record is created, a file type, a created date, a flag indicating whether the file is locked, and a list of arbitrary name-value mappings associated with the file (hereafter referred to as ‘fields’). This list of fields is implemented as a structured XML text document that is stored as a Character Large Object (CLOB). An additional table column stores field content that should be used for full text searching the file system. Two relationship columns serve to implement a hierarchical file system inside of flat database table. One record column stores a link to the unique ID of its parent file, establishing that file as a child of the parent file. A record with no parent ID specified is a child of the implicit root file. The second column stores the path of a given file inside the hierarchy tree, allowing for quick look-ups of file children.

Files may also have resources attached to them, such as binary images, movies, PDFs, etc. A second table, linked to the main file system table via a foreign key relationship, stores the resources associated with a given file as Binary Large Objects (BLOBs) inside of the database. Storing resources directly in the database allows for easy movement of entire systems of data.

Content and structural elements are stored equivalently in the file system, and are distinguished in this table only by their file type. A separate table is used to establish inheritance relationship between the structural file records. Thus, the structural repository is, in actuality, bootstrapped on top of a common content repository and structural elements are stored as a special type of content. The table used to maintain this linking maps a structural file to all structural files from which it inherits information and behavior inside the application.

Communication with the database file system by the application code, running in the Web application server, is through JDBC drivers that are provided by the database supplier and are supported on the host platform. Inside the application a set of Java classes wraps the JDBC driver to provide an abstracted view of the file system and the records it contains, thereby freeing the rest of the application from the burden of communicating with the database directly. These file system classes also optimize database performance by caching information retrieved from the database under certain circumstances and by pooling network connections to the DBMS. A separate set of classes is used to retrieve the structural information that is stored outside of the main file system implementation.

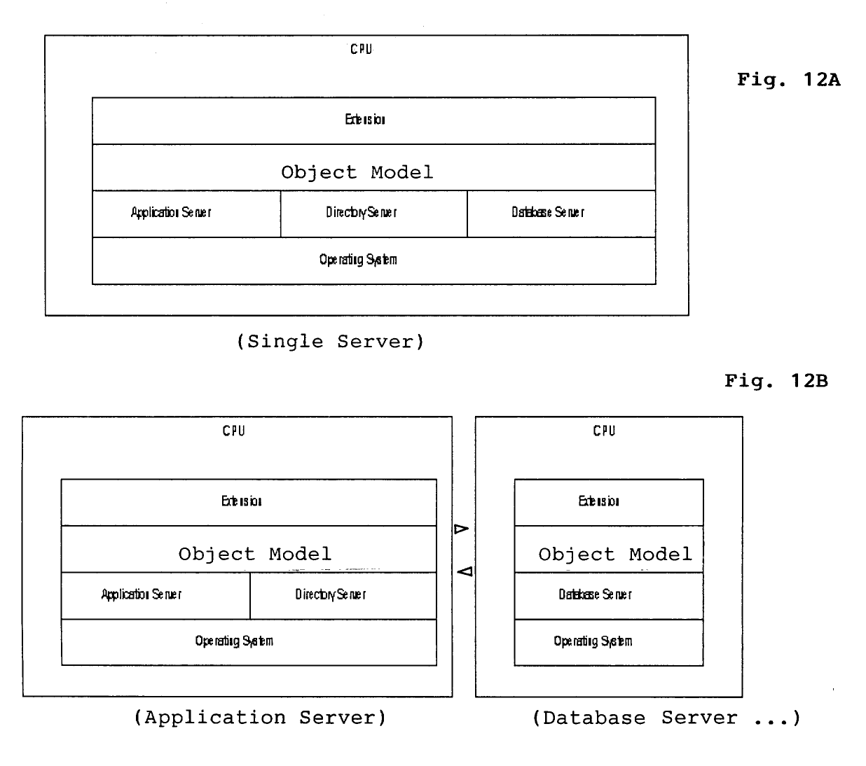

In FIGS. 12A and 12B, the system is shown implemented on a single server or, alternatively, an application server operable with one or more database or other servers. In the single server version, the operating system provides the environment for the application server, directory server, and database server components of the core system. The Object Model is implemented on this combined platform, and also drives any extension(s) to the system. The underlying code for executing the system is processed by the CPU. In the multiple server version, the Object Model is implemented across a separate application server and a database (and/or other server) components. The choice whether to use a single or multiple servers is determined by the efficiencies in the operation of the server components desired to be obtained. A server can serve up a number of hosted Web sites, but each one has its own Object Model insofar as each has its own collection of structural and content elements and instances of template hierarchies.

At its simplest level, the Object Model associates behaviors with file types inside of the file system. A Java class in the Object Model declares that it represents a file by extending the base database file class and declaring which file type it represents. Methods inside of this Java class implement the behavior of the object, such as what it does when it is saved back to the file system or deleted, or what it displays to a client (if it is a web content object). For structural elements, the representative classes also maintain the consistency of the inheritance relationships stored in the auxiliary tables in the DBMS. The Object Model is a collection of inter-related Java classes backed by file records stored in the DBMS that interact with both the Editor Interface and the Page Server to create the overall behavior of the application.

In addition to the file type classes, the Object Model uses many utility classes to centralize certain operations that are performed by many of the file classes or by the Editor or Page Server components.

The Object Model depends on many pieces of configuration information that describe, the physical setup of the server and database connection information as well as define which Object Model components are installed. Information relating to server setup and databases is stored in a central configuration database that can optionally store configurations for many instances of the Object Model application that are spread over many different servers. A set of Java classes, distinct from the Object Model, manage connecting and retrieving information from this central database. Information relating to which application components are installed is stored in configuration files, in both plain text and XML formats that exist in the local operating system file system.

Defining Tags in Templates and Documents with the Editor

The Editor is the interface to the Object Model used by the Web site designer to manage both the structure and content of a Web site. Users interact with the Object Model and database using an interface similar to that found in the Windows Explorer program in versions of Microsoft Windows™. Each file has an icon associated with it. The user can navigate through folders and drag-and-drop icons to move or copy files, and double-click to edit a file. The user can also right-click to reveal a menu of operations that can be performed on the selected file. Since both content and structural files are stored in the same way, they are manipulated using the same interface. However, the different file types are separated into different sections of the Editor to allow easy access restriction. The true difference between the two components only becomes apparent when the files are edited by the user.

The Editor is implemented as a set of Java Server Pages (JSPs), Java Servlets, JavaScript files and Cascaded Style Sheet (CSS) files. The JSP files and Servlets are served and processed by the Web Application Server, while the JavaScript and CSS are served to the client web browser, such as Microsoft Internet Explorer or Netscape Navigator, by the http server component of the Web Application Server.

Every file in the file system has a Java class associated with it to provide behavioral logic, as is explained above. Every file also has a JSP associated with it to allow the file's field data to be edited through the use of HTML forms by the application user. This JSP file is stored on the local server file system and its name and path are compiled into the corresponding file type class as a string constant. Through the use of the intermediate Java class, the data for every file in the virtual file system is linked to a page that can be used to edit it.

The Editor uses the concept of an ‘action’ to perform operations on files in the file system. An action is a Java class file that can receive arguments from the editor JSP pages and perform a predefined set of commands on a file using methods presented by the database wrapper classes. Configuration files in XML are used to specify which actions may be performed on which files. These files map files types to action class file names and to the text descriptions that appear in menus and on buttons. Examples of actions are EditFile, DeleteFile, ChangeFileAccess, and RelocateFile. When a user selects a file and chooses edit, for example, on a pop-up menu, a hidden frame in the web browser is used to send a request to the application server with the class file name associated with the EditFile action. This action queries the file's representative Java class to find the JSP page needed to edit it, and opens that JSP file in a new window, and passes the current document properties to the JSP so that they may be displayed for editing. When changes have been made to the document, the EditFile action accepts the changes sent back to the server by the browser and writes them into the database. Other actions function similarly: they take a request from the user and operate on the file system based on the data contained in the request.

When a user uses the Editor to create or edit a template, they are presented with a text area to enter a mixture of HTML text, inline scripting code and special object tags. The object tags are replaced by content objects when the template is rendered into a web page. HTML markup code can be inserted around the object tags to give layout instructions for the content that the objects incorporate. Inline scripting code can be interspersed with the tags and HTML to allow the layout of the template to be modified on the fly when the page is displayed.

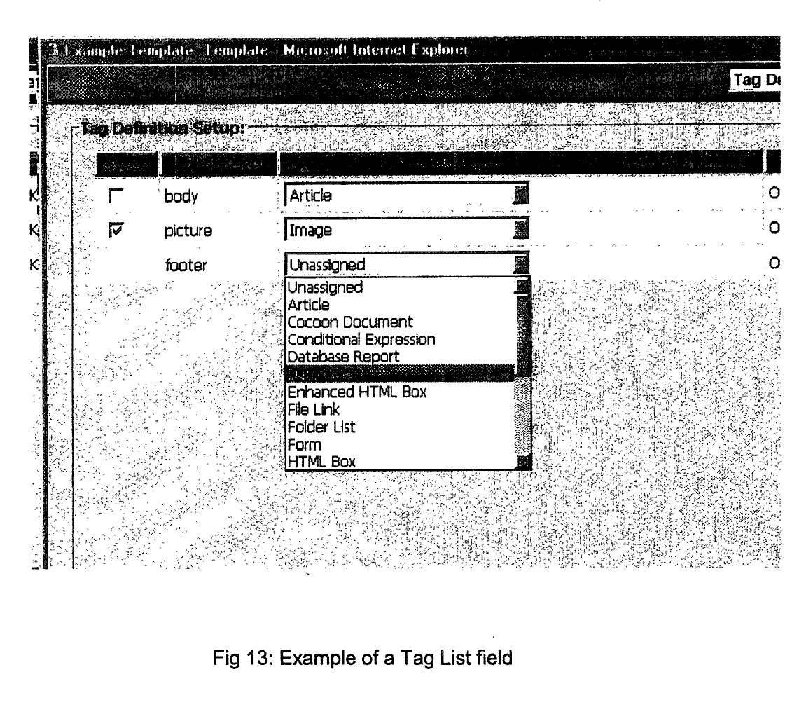

When the user has finished entering this content, JavaScript functions included upon editing the JSP page parse the content in the text area and determine the names of all tags that are present. A list is then generated in a different section of the editor page listing all tags that are present and to be filled with content objects. An HTML select control is placed next to each list and allow the user to use the mouse to pick any of the installed content objects to fill the tag. The list of installed objects is generated from the application configuration files mentioned above. The options the user chooses for each tag are compiled into a list and saved in a field inside of the template file. The tag-list field serves as the basis for computing object assignments for an Object List for an entire template hierarchy. A special string containing the tag name, whether it is defined or not, and the type of content object filling the tag is included for each in the content area. FIG. 13 shows an example of a screen shot of a dialog box of the Editor interface for setting up tag definitions. In this example, the tag is defined as assigned to a footer containing a “picture”.

The user has three options when assigning the contents of a tag. They can leave the tag untyped and undefined (i.e., unassigned). This means that the choosing of a content object to fill this tag is deferred to either an extension or a web page further up in the inheritance hierarchy and that no requirement is specified as to what kind of content object can fill the tag. The user can also choose to define a type for a tag but leave it undefined. This means that a predetermined kind of content object will be used to fill the tag, but the actual filling of the tag is still deferred to a later extension or document. These first two options merely write the users setting to the tag list field, since the actual action of filling the tag is deferred. The last option for a tag is to define it directly on the template. For an element to be defined in code in a template, it must be entered as type. With this option, any child of the template will inherit the locally defined content element as part of the web page that is displayed.

Java code inside the class file representing the template object ensures that the physical state of an inheritance hierarchy is consistent with the tag settings on a base template. This code must sync the local state of the template file in the database to most current tag list field, as well as, look through all descendents of the template to ensure that no definitions exist in their tag list fields which conflict with the new state of the template. For example, when a element is defined in a template, a new content file is created of the correct type and made a child file of the template file in the database file system and a button is displayed to allow the user to edit this content object. Since this element is now defined in the template, it no longer needs to be defined in descendent documents in order to fill all tags. Therefore, the code gathers all descendent documents and uses standard file system methods to remove any elements that are now redundantly filling the tag that was just defined. Descendents are gathered quickly by using the hierarchy data that is stored in the additional tables in the database repository.

When the user creates or edits an extension, they are initially not presented with a text area to edit markup HTML and add new tags. Instead, they are presented with a list of existing (inherited) tags. When an extension is opened, a set of routines starts at the base template of the inheritance hierarchy and loads its tag list. The routine then steps up through any extensions on the same branch as the extension being edited and merges in the changes to the master tag list introduced by the values in the tag list fields of the intermediate extensions. By looping in this fashion, changes at a higher level recognize all of the-changes made at a lower level. The combined tag list is then displayed on the editor page with tag definition boxes shown next to each tag to allow tag definitions to be changed. Any changes made to these definitions at the extension level will override any definitions or changes made further down in the hierarchy.

Using checkboxes on the tag definition screen, the user can configure the extension to simply inherit tag settings from its parent, or can choose to define a tag that has been previously typed in a parent, or can completely override the typing and definition status established in the parent and choose a new configuration for these attributes. The edited settings will be stored in the tag list field on the extension's database file, just as with a template.

The extension is not limited to merely refining the tags created by its parents. The user can choose to override or change a tag with a ‘tag expander.’ A tag expander is a type of meta-object that fills in a tag with collection of new tags and HTML markup. When the extension is saved, these new tags are integrated into the tag list saved for that extension and become available to all descendents of that extension. These new tags can be typed, defined, and expanded exactly like the tags from the original tag list.

When the user edits a document, they are presented with a more simplified view of the inheritance structure than when they edit an extension or template. In an extension or template, the user has access to all of the tags that exist in the tag lists of parent templates and extensions. In a document, the user only sees the tags that have been left undefined in the parent templates and extensions since these are the only tags which are relevant to the document. This tag list is retrieved using the same method used for extensions; however, previously defined tags are trimmed from the list before it is displayed. When a document is saved, in addition to checking the consistency of its tags, a reference to the unique ID of its immediate parent (either an extension or a template) is stored in a field for use by the Page Server.

Serving a Webpage with the Page Server

The page serving process starts when a request for a document comes to the Web Application Server from a client web browser. The request is forwarded to the Page Server servlet by the Application Server. The Servlet parses the URL contained in the request to determine which page has been requested. The URL can contain either the unique ID of the document being requested or the path to the document in the virtual file system. The Page Server uses the database wrapper classes to retrieve the document. For a production version of a Web site, as opposed to a development version, a subclass of the main database class which implements a cache of the files from the database is used. This cache functions by using Java serialization APIs to write the in memory representations of the virtual files into a physical file which exists in a temporary on the server file system. This system is the content cache.

After the document has been retrieved, either from the cache or from the database, access rights stored in the auxiliary tables in the database are checked against the identity of the client requesting the document. An access violation error is served if the user has insufficient access and the incident is recorded in the application log. If the client has sufficient access, then the serving process begins. First, the unique ID of the immediate parent template or extension is loaded from the stored field in the document to be served. This ID is used to retrieve a TemplateStream object from a ‘structural’ cache inside of the Page Server servlet. A TemplateStream is a Java object that contains an ordered series of StreamSegment Java objects which represent the combined HTML, runtime script, and object tags for a given template or extension. It is, in essence, an efficient summary of the page structure defined by a hierarchy. For an extension, the TemplateStream object incorporates all the content and objects that are inherited from parent templates and extensions. Also in the TemplateStream are segments which represent empty spaces left by tags which have not been defined in the template hierarchy. When a document is served, the contents of its tags are used to fill these empty segments, producing a complete, fully-resolved stream of content that can be sent back to the client.

If the structural cache does not contain a TemplateStream for a given document's parent extension or template, then a new one must be constructed by the Page Server. To construct a TemplateStream, the topmost parent ID (which was taken from the document field) is used to retrieve the file from the database. All parents of this file are then loaded, so that the entire inheritance hierarchy is held in memory. The process steps from the base template upward to generate a master tag list which takes into account all additions and removals made by extensions. At the same time a buffer is filled with combination of HTML and script that is included in each template. When the process is finished the server has a list of final tags and master layout dictating how these tags should be displayed.

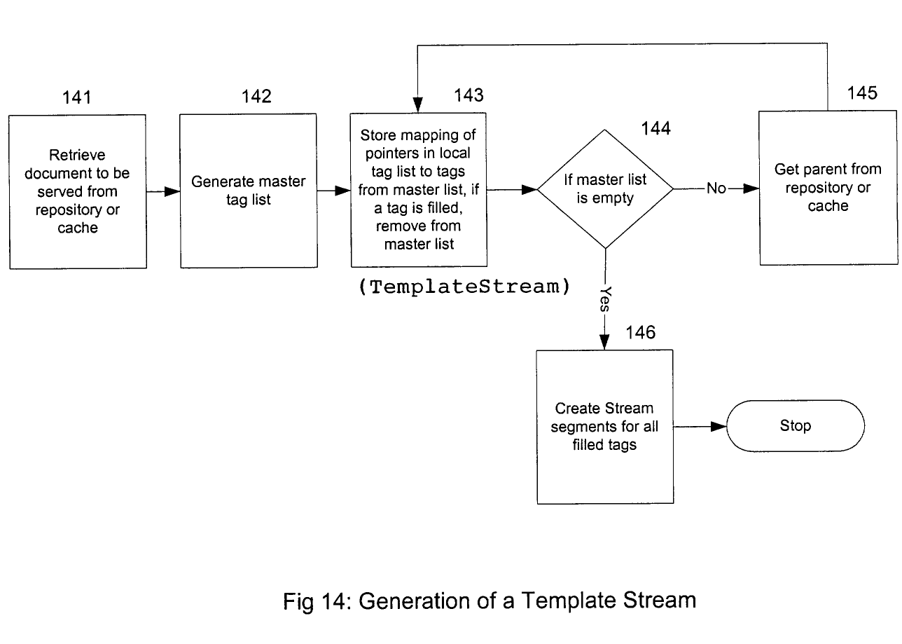

FIG. 14 illustrates the logic used by the Object Model to generate the TemplateStream table of all content and objects in a template hierarchy for a document. At block 141 the document for which a resulting document (webpage) has been requested is retrieved from the repository or cache, and at block 142 its Master Tag List is generated. Blocks 143, 144 and 145 perform a loop function where each next immediate parent starting with the document is retrieved from memory and its pointers on the local tag list is checked, and if it is filled (assigned), the tag pointer is added to the TemplateStream and the tag is removed from the Master Tag List. This loop continues until the Master Tag List is empty, and the completed TemplateStream object is passed to block 146 where Stream segments (for outputting/printing the elements) are created for all filled tags.

At the end of both processes, the server possesses a master layout containing the final text of the page and a mapping of content objects to the tags that occur in that page. The master layout is then parsed. It is separated into StreamSegments subclasses that represent the content. A StringSegment represents a section of HTML, a ScriptSegment represents an inline script block, a DocumentSegment represents a content element defined in a parent, and an EmptySegment represents a content tag that has not yet been filled. These segments are organized into a linked list where the segments are arranged in the order that they will be written out the network socket to the client. This link list becomes the backing element for a new TemplateStream. The Page Server then stores the TemplateStream in the cache keyed on the unique ID of the top level extension it is produced from.

Finally, the Document being served and the TemplateStream object are passed into a script interpreter which prints the StringSegments, interprets and runs any inline script code in ScriptSegments, prints the content generated by the content objects wrapped by DocumentSegments, and fetches the content elements in the Document corresponding to EmptySegments and prints them. When a content object is printed, a special Java method in each file wrapper class is run to generate the HTML corresponding to the object. In this way, the final web page is generated. Any flow control present in the ScriptSegment code is used by the script interpreter to determine if any segments need to be skipped.

In the manner described above, the Object Model provides a robust framework for building complex and highly-structured Web applications and managing content therein that exhibits inheritance, but is not object-oriented programming (OOP) in itself. Content elements (also called “web objects”) are, more or less, files that are replicated into tagged areas of templates. However, they are not necessarily static data, but can contain or refer to data from a database or dynamic data from extension system or an external system. In this manner, the complex inheritance relationships of basic structure, extensions, and content can be manipulated and modified in a visual, file-based manner by an author or Web site manager or administrator without ever writing source code. OOP has been solely confined to programming, i.e., the compiling or interpreting of code to produce binary applications. In the present invention, the Object Model represents an extension of the techniques that have been developed in OOP programming used in a new framework for developing Web applications. Essentially, the use of a visual editor to create and edit templates and documents replaces writing source code, and the use of a page server that constructs a resulting document from a template hierarchy replaces a compiler used to compile OOP code. The templates and documents replace OOP class hierarchies, and the content elements replace OOP data fields.

The hierarchical template inheritance model creates a robust architecture for developing Web site applications that is simpler to manage than the traditional file directory model of conventional web applications. Developers can easily customize the look and feel of a Web site application at a high level by defining a template hierarchy and allowing it to cascade throughout the application. The Object Model supports inheritance, overriding of objects between templates, and granular customization at the extended levels of the template hierarchy so that an unlimited span of webpage designs can be implemented by changing existing templates or adding template extensions, content objects, and resources, instead of the conventional practices of changing a coded webpage manually or building new ones from scratch.

It is to be understood that the foregoing description is intended to describe a preferred embodiment of the present invention, and that many modifications and variations thereof may be devised from the principles of the invention described. It is intended that all such modifications and variations be considered as within the spirit and scope of this invention, as defined in the following claims.

1. A method for developing an application for serving a document to a client in a client/server network comprising the following basic steps:
(a) defining a template for an intended document which specifies aspects of structure and content that the intended document is to have;
(b) defining at least one template extension for the intended document in a hierarchy with the template which specifies other aspects of structure and other content that the intended document is to have, wherein the template extension inherits the structure and content specified in the template;
(c) defining a document which refers to the template hierarchy of said template and said at least one template extension;
(d) defining a plurality of content objects to be incorporated in the intended document and referencing the content objects in the template, template extension, and/or document in order to cause the content objects to be incorporated in any resulting document;
(e) storing the template hierarchy of said template, at least one template extension, document, and content objects in a storage repository; and
(f) generating a resulting document in response to a client request by retrieving the template hierarchy and combining the structure and content inherited from said template and at least one template extension with the document and the content objects referenced therein.

2. A method according to claim 1, wherein the template, template extension, and document are created or edited using an editor component with a visual interface for the user.

3. A method according to claim 1, wherein the referencing of content objects in the template, template extension, and/or document is obtained by inserting tags as placeholders pointing to the content objects.

4. A method according to claim 3, wherein the tagged content objects defined in the template can be added to, modified, and/or overridden by the tagged content objects defined in the template extension.

5. A method according to claim 3, wherein a content object is defined in a template or template extension without an assignment of features, and the content object is defined with assigned features in a later template extension or the document.

6. A method according to claim 3, wherein the tags are inserted by creating or editing them using an editor component with a visual interface.

7. A method according to claim 1, wherein the application is a Web site application, and the resulting document is a webpage of the Web site that is served to a client on the client/server network.

8. A method according to claim 7, wherein the client/server network is any network of the group consisting of: an intranet; the Internet; an extranet; an e-commerce enterprise network; and a wireless network capable of receiving webpages.

9. A method according to claim 7, wherein the resulting document is a webpage generated by a page server that reconstructs a table of all content objects inherited from the template hierarchy associated with the webpage.

10. A method according to claim 1, further comprising the step of providing an integration interface for exporting data to and importing data from an external source in order to extend the reach of the application.

11. A method according to claim 1, further comprising the step of providing an extension interface to combine the application with an extension thereof in order to provide an extended application.

12. A system for developing an application for serving a document to a client in a client/server network comprising:
(a) an object model framework for defining structure and content in a template hierarchy including a master template, at least one template extension, a document, and content objects to be incorporated in any resulting document associated with the template hierarchy, wherein the document inherits structure and content objects defined in a parent template extension, the parent template extension inherits structure and content objects defined in any further template extension, and the furthest of any template extension inherits structure and content objects defined in the master template;
(b) an editor component having a visual interface to enable a user of the system to create and edit a template hierarchy by visually-oriented commands;
(c) a repository for storing data defining the template hierarchy created by the user using the editor component and visual interface; and
(d) a page server for generating a resulting document in response to a client request by retrieving the template hierarchy data from the repository and combining the structure and content objects inherited from said template and at least one template extension with the document and the content objects referenced therein into the resulting document.

13. A system according to claim 12, wherein content objects are referenced in the template, template extension, and/or document by tags inserted as placeholders for pointing to the content objects as stored in the repositories.

14. A system according to claim 12, further comprising an extension manager component for managing interconnection of the object model framework to outside or extended resources.

15. A system according to claim 12, further comprising an integration interface for managing interfacing of data imported from or exported to any external systems.

16. A system according to claim 12, wherein the application is a Web site application, and the resulting document is a webpage of the Web site that is served to a client on the client/server network.

17. A system according to claim 16, wherein the client/server network is any network of the group consisting of: an intranet; the Internet; an extranet; an e-commerce enterprise network; and a wireless network capable of receiving webpages.

18. A system according to claim 16, wherein the resulting document is a webpage generated by a page server that reconstructs a table of all content objects inherited from the template hierarchy associated with the webpage.

19. A system according to claim 18, wherein the page server retrieves all of the tagged content objects listed on the table from the system repositories and assembles them in the structure of the webpage inherited from the template hierarchy.

20. A system according to claim 12 which is adapted to any applications development environment so as to employ visual interfaces to allow a user to build complex and highly-structured applications through visually-oriented commands, without having to program in source code.
